(19) United States
(12) Patent Application Publication
(10) Pub. No.: US 2025/0079587 A1
(43) Pub. Date: Mar. 6, 2025

(54) SYSTEM AND METHOD FOR CURING ADHESIVE IN A CELL CARRIER

(71) Applicant: SABIC GLOBAL TECHNOLOGIES B.V., Bergen op Zoom (NL)

(72) Inventors: Anil TIWARI, Maastricht (NL); Richard BRIDGEWATER, Worcestershire (GB); Carlos PEREIRA CADENA, Putnam Valley, NY (US); Dinesh MUNJURULIMANA, South Lyon, MI (US)

(21) Appl. No.: 18/724,940

(22) PCT Filed: Jan. 4, 2023
(86) PCT No.: PCT/EP2023/050113

§ 371 Date: Jun. 27, 2024

(30) Foreign Application Priority Data
Jan. 17, 2022 (EP) 22151846.7

(51) Int. Cl. H01M 50/171; H01M 50/242

(52) U.S. Cl. CPC H01M 50/171; H01M 50/242

(57) ABSTRACT

An apparatus for fixing a plurality of battery cells in an array including a carrier, that is planar, to carry the plurality of cells, the carrier having an outer major surface and an inner major surface opposite the outer major surface, the carrier defining a plurality of battery wells disposed adjacent one another along the inner major surface, wherein a well of the plurality of battery wells defines a sidewall and a floor, together conform to a cell of the plurality of battery cells and to constrain movement of the cell through the floor of the carrier and laterally along the major surface of the carrier, wherein the floor defines: a center aperture; and a plurality of apertures spaced apart from the center aperture, and a cavity of the well, with the plurality of apertures disposed in the cavity.

### TECHNICAL FIELD

The present invention relates to a cell carrier for a battery pack, in particular a system and method for curing adhesive in a cell carrier.

### BACKGROUND

Power sources for battery-electric vehicles, for example vehicles in which an electric motor is the prime mover, may be formed of a number of discreet batteries, or cells, that are interconnected. Using a number of smaller cells can benefit manufacturers by decreasing the complexity of the battery cells, which can lead to higher cell manufacturing rates and yields. For example, batteries can be manufactured in a roll-to-roll process, such as a jelly-roll process, which can run at high manufacturing speeds, translating to lower manufacturing cost. Many jelly-roll constructions, however, are limited in size and/or the number of anodes and cathodes used, and as a result, demonstrate a limited voltage or capacity. To overcome these limitations, discreet cells can be linked together, either directly, or indirectly via electronics such as a battery management system, to achieve desired performance as a set. A plurality of cells linked as such is often referred to as a battery pack. Battery packs can package cells in an efficient manner that is compatible with the unique operating conditions of vehicles. In some cases, manufacturers package battery cells and ancillary components such as battery management systems, cooling systems, and the like into a battery pack.

With such packaging, each cell can be placed in a carrier in a manner that fixes the cell, protected from stress caused by the harsh operating conditions of a vehicle. If the cell is to be linked with other cells, often the cell is first placed in the carrier, secured in place, and then linked via a joining operation, which may include welding the cell to a busbar that is linked to other cells or electronics. Cell packaging can also assist with the propagation of thermal runaway from cell to cell by increasing the thermal resistance between cells or otherwise containing the thermal anomaly.

Early attempts at packaging cells often placed the cells in a carrier, and then adhered the cells to the carrier with a curable resin.

EP2104121B1 depicts a holder for battery cells adapted to place the cells in thermal communication with a heat-conductive insulating grease.

U.S. Pat. No. 9,972,814 (the '814 patent) shows a transparent carrier or fixture that is transparent to a particular wavelength of ultraviolet radiation, promoting greater intensity of UV radiation in target zone while diminishing the intensity of UV radiation in other parts, which can decrease the chances of the UV radiation damaging those parts. This approach relies on specialized refraction and roughening techniques, and fails to limit UV transmission through the fixture, which presents a danger for persons assembling the battery pack.

U.S. Pat. No. 8,057,630 provides for selective curing with UV, but suffers shortcomings discussed in the '814 patent.

Chinese Utility Patent No. 205609582U shows a through hole 21 for accommodating glue to adhere two adjacent single cells, but provides limited paths of UV radiation transmission, which can decrease the effectiveness of a curing operation.

In particular, these approaches rely on special carriers formed of a material that is compatible with transmitting radiation such as UV light. However, such carriers can be expensive to manufacture, requiring complex shapes and molding tools. More importantly, these complex optical carriers can be damaged in manufacturing which can decrease the efficiency of radiative curing or even result in uncured resin. It may also be a problem to add a flame retardant to the material the carrier is formed from, as it can interfere with the optics of the carrier. What is needed is a solution for allowing for radiative curing in a more robust and simple manner.

### SUMMARY

As discussed above, it is preferable for a battery cell carrier to be formed of material that is UV transparent and at the same time flame retardant. Flame retardant properties can be achieved by adding flame retardant additives to a material such as a thermoplastic. While such additives assist in reducing the flammability of the material, they can also reduce UV transparency, and thus make it difficult use the carrier as a lens for transmitting UV light to a resin to be cured. The requirement for UV light transmissibility and flame retardancy are in opposition to one another when the carrier is a lens to transmit the UV light. New approaches that meet these contradictory requirements are important to allow for designers to use a broad range of materials. The present disclosure provides a material-independent approach that allows for resin adhesive to be exposed to UV which allowing for the formation of robust injection-molded shapes that do not rely on complex tooling, and those provide for low-cost and robust injection molding.

### BRIEF DESCRIPTION OF THE DRAWINGS

FIG. 1A shows a perspective view of a carrier, according to some examples.

FIG. 1B is a side view of the carrier of FIG. 1A.

FIG. 2A is a top-right perspective view of a carrier assembly, according to an example.

FIG. 2B is a bottom-right perspective view of the carrier assembly of FIG. 2A, with a bottom carrier missing and one cell shown in broken lines.

FIG. 2C is a bottom-right perspective view of the carrier assembly of FIG. 2A, with the bottom carrier missing and all but one cell missing.

FIG. 3A is a top perspective view of a carrier and a cell in broken lines.

FIG. 3B is a close up of section 3B in FIG. 3A.

FIG. 3C is a top view of the cell void FIG. 3B.

FIG. 3D is a top view of the carrier FIG. 3C below a cell.

FIG. 4A is a top view of a well including 3 cavities, according to some examples.

FIG. 4B is a perspective view of a cavity of FIG. 4A, showing apertures.

FIG. 4C is a close up top view of the cavity in FIG. 4A.

FIG. 5A shows a top view of a floor with a pattern of apertures, according to an example.

FIG. 5B is a close up taken along section 4B-4B in FIG. 5A.

FIG. 6 is a method to secure a battery cell to a carrier, according to some examples.

### DETAILED DESCRIPTION

This present disclosure introduces a design feature in a cell carrier used to support cells in a battery module of an electric vehicle battery pack. A cell carrier can hold cells in stacks, together. The stacks can then be connected in series to generate desired amount of voltage and current. To avoid squeaking and rattling of cell in a cell carrier, cells can be adhesively bonded to the cell carrier. A Ultra Violet (UV) curable adhesive can be used to bond the cell with the cell carrier. There needs to be a passage for light either through the cell carrier material, as disclosed in the prior art, or through apertures in the cell carrier as set forth herein. If the cell carrier is not UV transparent, the bonding between the cell and cell carrier can be weak and it can take an undesirably long time to complete curing of the resin.

The cell carrier material can include flame retardant so that it has flame retardant properties. Such as design can reduce instances or the severity of thermal run-away in the event of short circuit in a cell. Ingredients compounded in a thermoplastic material used to make the cell carrier can make it flame retardant. These ingredient can increase the transmission loss for elector magnetic rays. This can make it harder for Ultra-Violet rays to pass through the material. As such, flame retardant additives can reduce Ultra-Violet transmission through the material.

As set forth herein, design features in the cell carrier are provided to improve exposer of adhesive to UV rays with materials that have limited UV transmission. These design features are explained in details in the following sections.

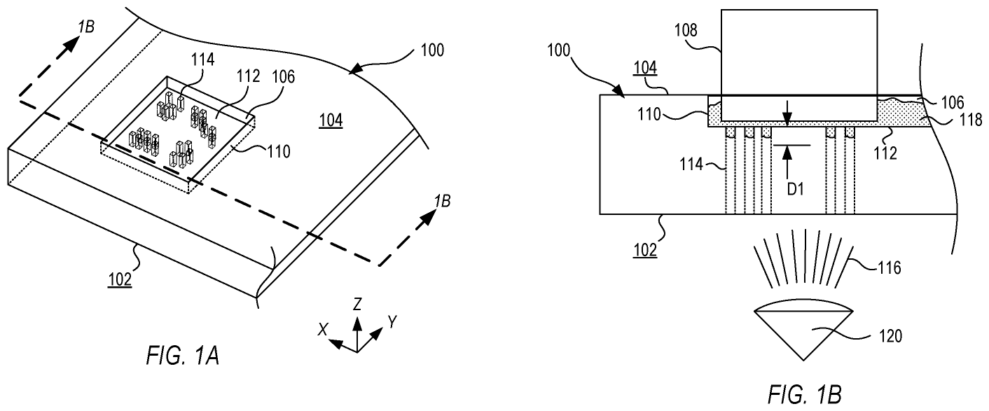

FIG. 1A shows a perspective view of a carrier, according to some examples. FIG. 1B is a side view of the carrier of FIG. 1A. The carrier 100 can be used for fixing a cell 108 in the carrier. Each cell 108 can be cylindrical. Alternatively, each cell 108 can be prismatic. Each cell 108 can be around 21 mm in diameter, although the present subject matter is compatible with many other cells. A cell 108 can be cylindrical in an X-Y plane cross-section parallel a major surface of the carrier.

The carrier 100 can be formed of a polymeric material such as a thermoplastic. A thermoplastic carrier 100 can be formed of polypropylene, polyethylene, polyamide, polycarbonate, PBT, and the like. The carrier can be formed of one or both of LEXAN 945 and CYCOLOY 7240. The carrier 100 can be formed of a resin including a flame retardant additive. Flame retardant can include any flame retardants known to be compatible as thermoplastic additive, including halogen free flame retardants.

The polymeric material is chosen based upon the desired properties, such as impact properties and long term heat stability. Examples of polymeric materials include, but are not limited to, polyesters, polycarbonates, polystyrenes (e.g., copolymers of polycarbonate and styrene, polyphenylene ether-polystyrene blends), polyimides (e.g., polyetherimides), acrylonitrile-styrene-butadiene (ABS), polyarylates, polyalkylmethacrylates (e.g., polymethylmethacrylates (PMMA)), polyolefins (e.g., polypropylenes (PP) and polyethylenes, high density polyethylenes (HDPE), low density polyethylenes (LDPE), linear low density polyethylenes (LLDPE)), polyamides (e.g., polyamideimides), polyarylates, polysulfones (e.g., polyarylsulfones, polysulfonamides), polyphenylene sulfides, polytetrafluoroethylenes, polyethers (e.g., polyether ketones (PEK), polyether etherketones (PEEK), polyethersulfones (PES)), polyacrylics, polyacetals, polybenzoxazoles (e.g., polybenzothiazinophenothiazines, polybenzothiazoles), polyoxadiazoles, polypyrazinoquinoxalines, polypyromellitimides, polyquinoxalines, polybenzimidazoles, polyoxindoles, polyoxoisoindolines (e.g., polydioxoisoindolines), polytriazines, polypyridazines, polypiperazines, polypyridines, polypiperidines, polytriazoles, polypyrazoles, polypyrrolidones, polycarboranes, polyoxabicyclononanes, polydibenzofurans, polyphthalamide, polyacetals, polyanhydrides, polyvinyls (e.g., polyvinyl ethers, polyvinyl thioethers, polyvinyl alcohols, polyvinyl ketones, polyvinyl halides, polyvinyl nitriles, polyvinyl esters, polyvinylchlorides), polysulfonates, polysulfides, polyureas, polyphosphazenes, polysilazanes, polysiloxanes, fluoropolymers (e.g., polyvinyl fluoride (PVF), polyvinylidene fluoride (PVDF), polyvinyl fluoride (PVF), fluorinated ethylene-propylene (FEP), polyethylene tetrafluoroethylene (ETFE)), polycarbonate-siloxane block copolymer (such as LEXAN™ EXL Resin), terephthalate ester of resorcinol (ITR) (such as LEXAN™ SLX Resin), N-phenylphenol phthaleinylbisphenol (PPP-BP) (such as LEXAN™ XHT Resin), or a combination comprising at least one of the foregoing. Thus, the carrier can be formed of one or both of LEXAN 945 and CYCOLOY 7240.

The polymeric material can include an additive. The additive can include at least one of a foaming agent, a flame retardant, an impact modifier, flow modifier, filler (e.g., a particulate polytetrafluoroethylene (PTFE), glass, carbon, mineral, or metal), reinforcing agent (e.g., glass fibers), antioxidant, heat stabilizer, light stabilizer, ultraviolet (UV) light stabilizer, UV absorbing additive, plasticizer, lubricant, release agent (such as a mold release agent), antistatic agent, anti-fog agent, antimicrobial agent, colorant (e.g., a dye or pigment), surface effect additive, radiation stabilizer, anti-drip agent (e.g., a PTFE-encapsulated styrene-acrylonitrile copolymer (TSAN)), or a combination thereof. For example, a combination of a heat stabilizer, mold release agent, and ultraviolet light stabilizer can be used. In general, the additives are used in the amounts generally known to be effective.

The carrier 100 can be formed of a thermoplastic. Examples of thermoplastic include, but are not limited to, polypropylenes such as UL94 V0 polypropylene compounds with high specific strength and specific stiffness, polycarbonate and/or ABS compounds such as UL94 V0 high flow PC/ABS compound flame retardant polycarbonate compounds with UL94 V0 rating at low thickness, polyester compounds with low temperature ductility for impact absorbers, polyethylene, polystyrene, polyvinyl chloride, polytetrafluoroethylene, and the like. The carrier 100 can optionally be machined from a metal such as aluminum.

The carrier 100 can be transparent, translucent, or opaque. The carrier 100 can be formed of a substantially opaque thermoplastic. Translucence or opacity can be caused, in part, by the addition of flame retardant. The carrier can be formed using known methods of forming thermoplastics, including injection molding. The carrier 100 can be formed of a thermoplastic that is formed of a flame retardant.

A plurality of battery cells can be arranged in an array. The battery cells can be fixed in an array. The carrier 100 can be planar, as pictured. The carrier 100 can carry the plurality of cells in use. The carrier 100 can have an outer major surface 102 and an inner major surface 104 opposite the outer major surface 102. The carrier 100 can define one or more battery wells 106. The battery wells 106 can be disposed adjacent one another along the inner major surface 104. A well 106 can define a sidewall 110. The well 106 can define a floor 112. The well 106 can conform to a cell 108 to constrain movement of the cell 108, such as through the floor 112 of the carrier 100. The well 106 can conform to a cell 108 to constrain movement laterally in the X-Y direction along the inner major surface 104 of the carrier 100.

The well 108 can be sized to conform to a cylindrical cell. The well 108 can be sized to conform to a prismatic cell. Each cell 108 can be sized to interference fit in a battery well 106. Each cell 108 can be sized to clearance fit the battery well 106. In some examples, the well 106 is quadrangular, such as cuboid or rectilinear in shape. In some examples, the well 106 is cylindrical. The well 106 can have a draft on its sidewalls. The well 106 can be slot or channel shaped, having a U-shaped cross-section in the X-Z or Y-Z plane.

One or more apertures 114 can be disposed through the carrier 100. The apertures provide a portal or lumen through which radiant energy 116, such as UV light, can pass through the carrier 100 to impinge on an uncured resin 118 to cure the resin. An emitter 130 can emit the radiant energy 116. The cells 108 can thus be adhered, fixed, joined, etc. to the carrier 100.

The resin 118 can be any radiation-curable resin. The emitter can be any emitter that emits a radiation to cure a resin. Although a UV-curable resin, in combination with a UV light are preferred, IR curing, or even convection curing, can be used. The resin can be an air-curable resin cured through exposure to air through an aperture 114.

The radiant energy 116 can be emitted during resin application, or following resin application. The UV light can be constantly shining, or can intermittently emit radiation.

The resin 118 can be selected such that it has a viscosity at room temperature such that it flows or descends a selected distance D1 down an aperture 114 in an uncured state. The aperture 114 cross-sectional area, and/or shape can selected in combination with the resin viscosity to control distance D1. The time between application of the resin and the application of the radiant energy 116 can be selected to control the distance D1. The apertures 114 can be injection molded at a selected cross-sectional area in the carrier 100.

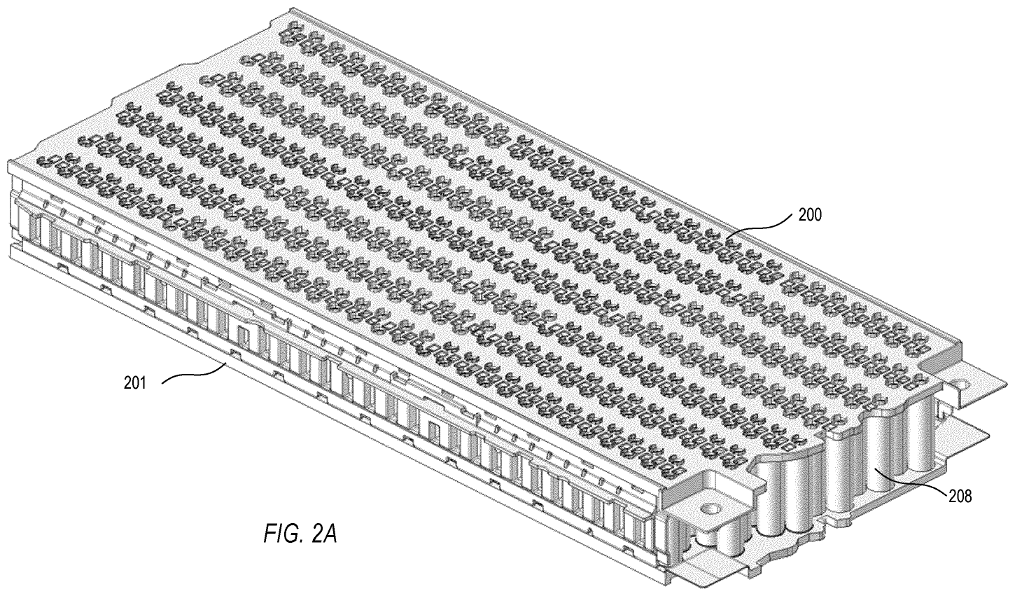

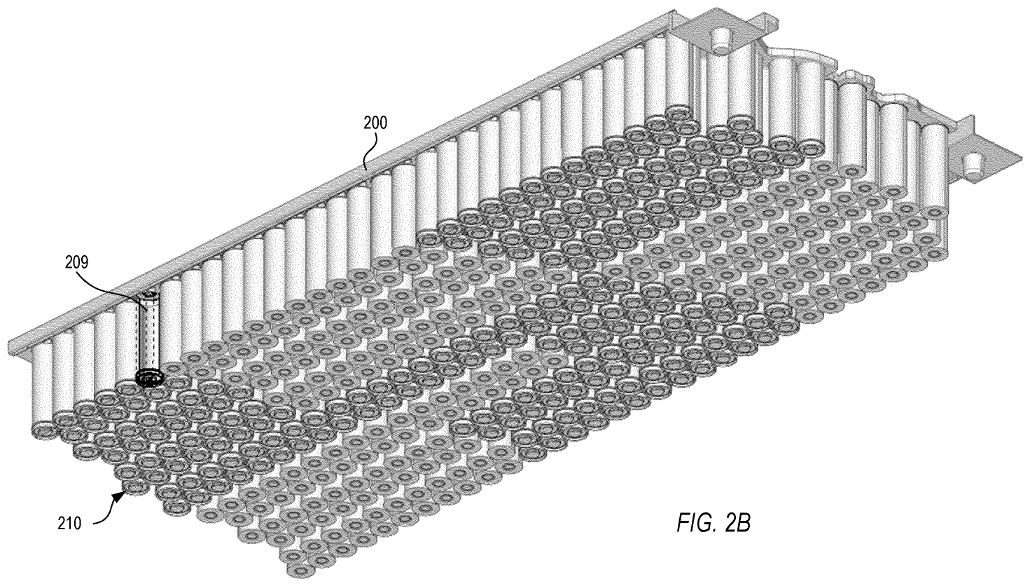

FIG. 2A is a top-right perspective view of a carrier assembly, according to an example. FIG. 2B is a bottom-right perspective view of the carrier assembly of FIG. 2A, with a bottom carrier missing and one cell shown in broken lines. FIG. 2C is a bottom-right perspective view of the carrier assembly of FIG. 2A, with the bottom carrier missing and all but one cell missing.

FIGS. 2A-2C show cells assembled with the cell carrier. There are two cell carriers, a top carrier and a and bottom carrier. Cells 208 can be assembled in wells provided in the cell carrier. UV curable adhesive can be dispensed at number of locations in cavities in the floor. The cells can be seated in the wells, over the cavities, with resin dispensed between the cell and the floor, localized to the cavity. A top cell carrier can be attached to the opposing side of the cells, and the entire assembly can be exposed to UV light both from the top and from the bottom side. The UV curable adhesive can cure and bonds the cell with the cell carrier. This can ensure that cells are completely constrained to move with reference to the cell carriers, which can avoid squeaking and rattling sounds while a vehicle is in motion. the amount of constraint depends on how well the cells are bonded with the cell carrier, which in turns depends on the UV transmissibility of cell carrier material. If the UV transmission of cell carrier material is limited, the bond may not have adequate strength or it will have longer curing time. Thus, the number of apertures and aperture groups and resin cavities can be adjusted for various applications.

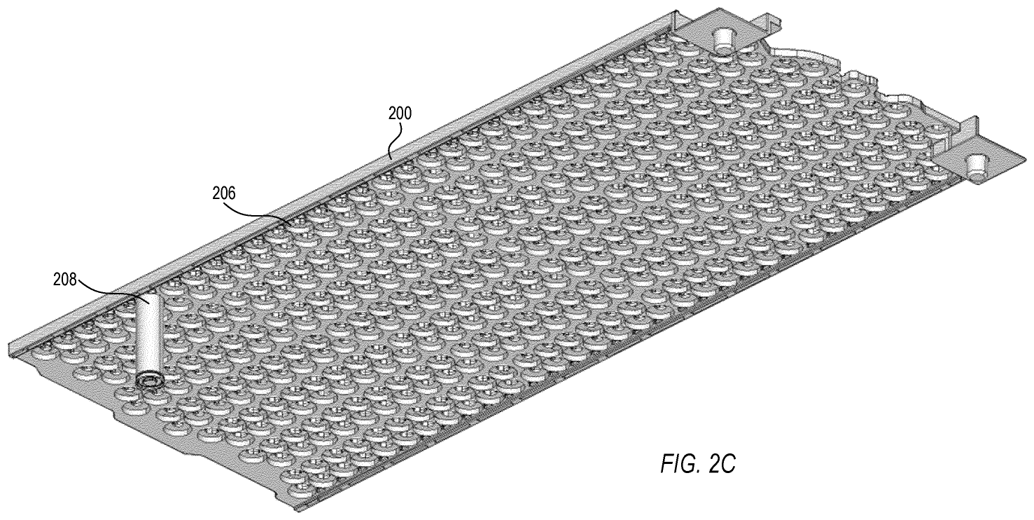

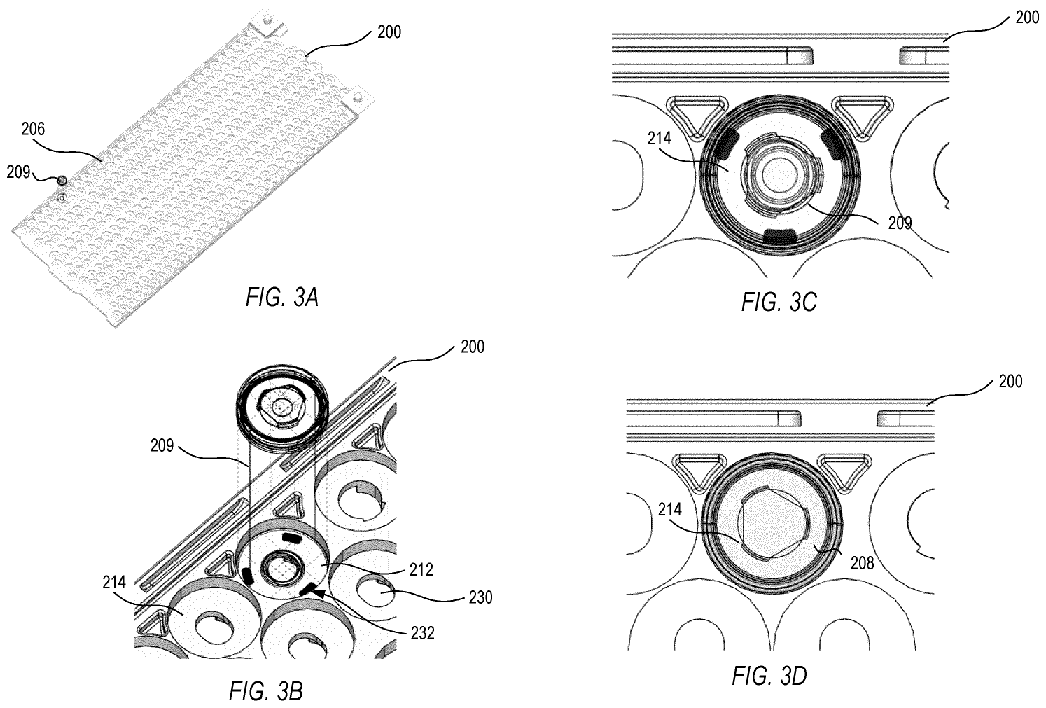

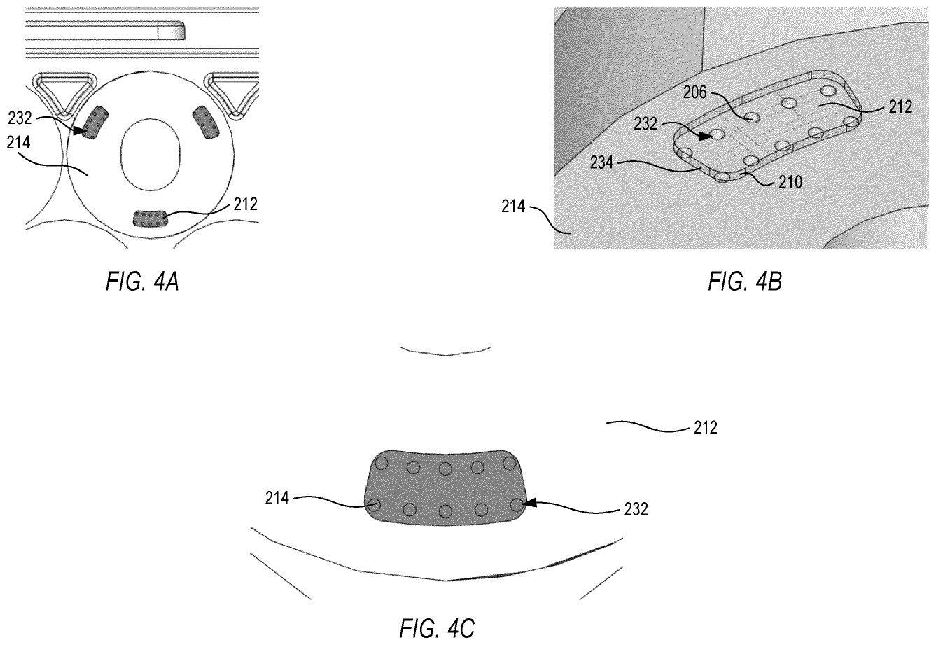

A top carrier 200 can be combined with a bottom carrier 201, sandwiching a plurality of cells 208 between the top carrier 200 and the bottom carrier 201. In FIG. 2B, a missing cell void 209 is shown for illustrative purposes. The cell assembly 211 shows that a number of cells may be anode down, while others are cathode down. In FIG. 2C, the cell void 209 is shown. A plurality of battery wells 206 is shown. These are illustrated with better detail in FIGS. 3A-3D and FIGS. 4A-C.

FIG. 3A is a top perspective view of a carrier and a cell in broken lines. FIG. 3B is a close up of section 3B in FIG. 3A. FIG. 3C is a top view of the cell void of FIG. 3B. FIG. 3D is a top view of the carrier below a cell. The carrier 200 shows a number of battery wells 206. Each well can define a floor 212. Each floor can define a center aperture 230. Each well 206 can define a plurality of apertures 214. A plurality of apertures 214 can be organized in at least one group 232. A group can be spaced apart from the center aperture 230. An aperture 214 can define a cylindrical top opening, as illustrated, but other shapes can be used.

FIG. 4A is a top view of a well including 3 cavities, according to some examples. FIG. 4B is a perspective view of a cavity of FIG. 4A, showing apertures. FIG. 4C is a close up top view of the cavity in FIG. 4A. A target zone or cavity 234 can be defined in the floor 212 of the well 206. The plurality of apertures 214 can be organized in at least one group 232 disposed in the cavity 234. An aperture 214 can have a diameter of from about 0.5 mm to 2.0 mm. A portion of the floor 212 proximal the group 232 can be contoured to define a space between the cell when disposed in the well 212 and fixed in the well to the carrier. The cavity 234 define the space. A cell 208 can be clearance fit in the well 212. A clearance fit is illustrated in FIG. 1B.

The size of each of the plurality of apertures can be selected as a UV-curable-adhesive flow-restricting aperture sized to commutate light such as UV light. The size of the aperture can be selected to restrict the liquid flow of UV-curable adhesive in liquid form to a selected flow rate at a selected temperature.

A system can be constructed including an adhesive cured by one or more of the group comprising light and ultraviolet radiation, the adhesive coupling the battery cell 208 to the carrier. In some systems, the cells 208 are cured in place to each of a top carrier 200 and the bottom carrier 201. A top well of the plurality of battery wells can define a top sidewall and a top floor, together defining a top cavity shaped to conform to the cell of the plurality of battery cells and to constrain movement of the cell through the top floor of the carrier 200 and a bottom carrier 201. The cells can be fixed laterally, with respect to each carrier, along an inner major surface of the carrier.

In some embodiments, some or all the thermoplastic material parts of the assembly may comprise one or more of the following: additives and/or stabilizers like anti-oxidants, UV stabilizers, pigments, dyes, adhesion promoters, and a flame retardant e.g. mixture of an organic phosphate compound (for example piperazine pyrophosphate, piperazine polyphosphate and combinations thereof), an organic phosphoric acid compound (for example phosphoric acid, melamine pyrophosphate, melamine polyphosphates, melamine phosphate) and combinations thereof, and zinc oxide, and/or a filler, e.g., fibers. For example, a fiber-filled polyolefin can be used. Possible fiber material may include at least one of glass, carbon, aramid, or plastic, preferably glass. The fiber length can be chopped, long, short, or continuous. In particular, long glass fiber-filled polypropylene (e.g. STAMAX™ available from SABIC) may be used. Long fibers are defined to have an initial fiber length, so before molding, of at least 3 mm.

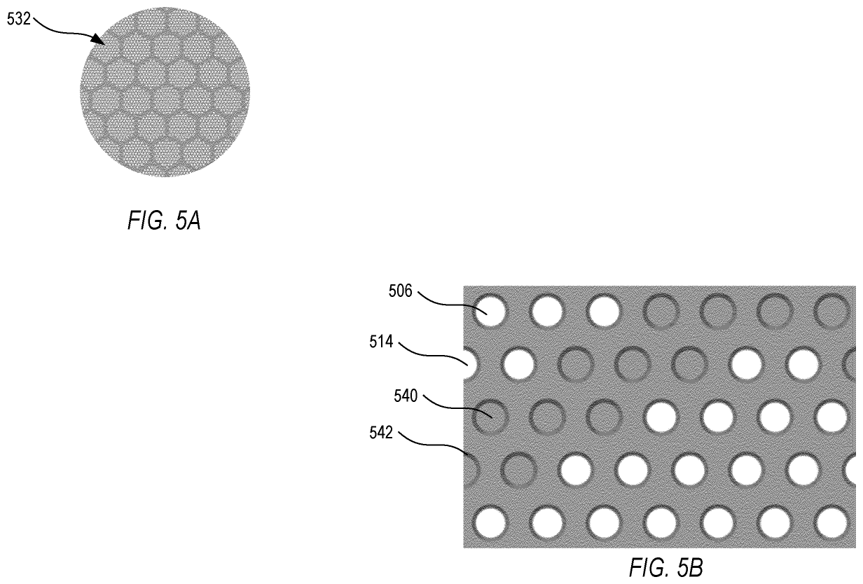

FIG. 5A shows a top view of a floor with a pattern of apertures, according to an example. FIG. 5B is a close up taken along section 4B-4B in FIG. 5A. A group of apertures 506 can be disposed in a carrier floor 514. They can be organized in a group 532. A back-rib 540 can be molded into the floor 514 to provide structure for the floor, defining recesses 542. As such, the entire floor can be covered with apertures or recesses, providing adequate structure and increased surface area for resin versus a floor with no recesses. Perforated structures can be made in injection-molded structure such as is used in a speaker grill. Such perforated structure can be created near the rest area of the cell in the cell carrier selectively where the adhesives are applied, such as in a cavity.

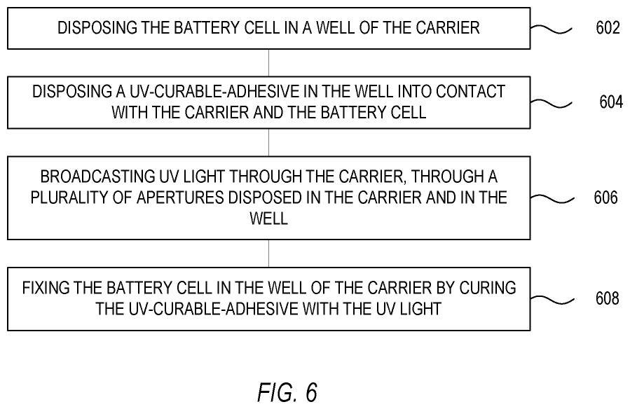

FIG. 6 is a method to secure a battery cell to a carrier, according to some examples. A method can include securing a battery cell to a carrier. At 602, the method comprises disposing the battery cell in a well of the carrier. The carrier can have a planar shape in an X-Y plane, such that the battery cell is aligned to the carrier and constrained from moving along the Z-direction and in the X-Y plane.

At 604, the method can include disposing a UV-curable-adhesive in the well into contact with the carrier and the battery cell. This can in

At 606, the method can include broadcasting UV light through the carrier, through a plurality of apertures disposed in the carrier and in the well. The plurality of apertures can be organized in a group that is offset from a center aperture of the well.

At 608, the method can include fixing the battery cell in the well of the carrier by curing the UV-curable-adhesive with the UV light.

The battery cell used in the method can be one of a plurality of battery cells, and wherein fixing the battery cell in the well occurs simultaneous with other cells of the plurality of battery cells.

The carrier used in the method can be bottom carrier. The method can comprise sandwiching the cell between the bottom carrier and a top carrier. The method can comprise fixing the battery cell in the bottom carrier and the top carrier simultaneously. The method can include broadcasting the UV light. The method can include broadcasting the light through a top plurality of apertures disposed in the top carrier. This can be simultaneous, or in a sequence.

A method can include dispensing a curable resin into battery wells. The method can include disposing cells into the battery wells of a bottom carrier. The method can include curing the resin to fix the cells to the bottom carrier. The method can include dispensing curable resin into a top carrier. The method can include rotating a bottom carrier fixed to cells and sandwiching the cells between the top carrier and the bottom carrier. The method can include curing the resin dispensed in the copy carrier to the cells to fix the cells to both the top carrier and the bottom carrier.

Various methods can comprise focusing UV light on the plurality of apertures such that the UV light does not shine on unintended targets, such as sensors or operators. Various methods include fixing the battery cell creates a bond between the cell and the carrier that is equivalent to a bond formed by transmitting UV light through a translucent carrier that does not have the plurality of apertures.

The term “battery” is defined herein to include all kind of batteries, preferentially but not limited lithium-ion batteries, in particular the one comprising pouch battery cell(s), which may undergo swelling due to the buildup of pressure within the cell. Swelling may result in shifting of the internal components of the pouch cells. For example, the electrode of the pouch cell may separate, degrading the chemical properties of the prismatic cell. Further, uncontrolled swelling of the pouch cells may drastically decrease their efficiency and product life. Accordingly, it would be desirable to provide compression to the pouch cells to protect their chemical integrity, and thus their efficiency and product life.

The term “battery pack” is defined herein to include a battery enclosure containing a battery according to various examples.

The term “Electric vehicle battery assembly” is defined herein to include at least a battery pack surrounded by a frame to maintain it, a upper enclosure and a lower enclosure.

The present application describes various technical features and advantages with reference to the FIGS. and/or to various embodiments. One skilled in the art will understand that the technical features of a given embodiment may in fact be combined with features of another embodiment unless the opposite is explicitly mentioned or if it is obvious that these features are incompatible and that the combination does not provide a solution to at least one of the technical problems mentioned in the present application. Further, the technical features described in a given embodiment may be isolated from the other features of this embodiment unless the opposite is explicitly mentioned.

It should be obvious for persons skilled in the art that the present invention allows embodiments in many other specific forms without departing from the field of application of the invention as claimed. Therefore, the present embodiments have to be considered as an illustration, but may be modified in the field defined by the scope of the appended claims, and the invention should not be limited to the details given above.

1. An apparatus for fixing a plurality of battery cells in an array, the apparatus comprising:
a carrier, that is planar, to carry the plurality of battery cells, the carrier having an outer major surface and an inner major surface opposite the outer major surface, the carrier defining a plurality of battery wells disposed adjacent one another along the inner major surface,
wherein a well of the plurality of battery wells defines a sidewall and a floor, together conform to a cell of the plurality of battery cells and to constrain movement of the cell through the floor of the carrier and laterally along the inner major surface of the carrier,
wherein the floor defines:
a center aperture; and
a plurality of apertures spaced apart from the center aperture,
wherein a portion of the floor proximal the apertures is contoured to define a space between the cell when disposed in the well and fixed in the well to the carrier,
wherein a cavity is defined in the floor of the well, with the plurality of apertures disposed in the cavity.

2. The apparatus of claim 1,
wherein the plurality of apertures are organized in at least one group,
wherein the portion of the floor is proximal the group, and
wherein the plurality of apertures organized in at least one group are disposed in the cavity.

3. The apparatus of claim 1, wherein the carrier is formed of an opaque thermoplastic.

4. The apparatus of claim 1, wherein the carrier is formed of a thermoplastic that is formed of a flame retardant.

5. The apparatus of claim 1, wherein the cell is cylindrical and has a diameter of around 21 mm.

6. A system comprising the apparatus of claim 1, and further comprising:
an adhesive cured by one or more of the group comprising light and ultraviolet radiation, the adhesive coupling the plurality of battery cells to the carrier.

7. The system of claim 6, wherein each one of the plurality of apertures has a smaller diameter than each one of the plurality of battery cells to thereby define a UV-curable-adhesive flow-restricting aperture that is configured to commutate a liquid flow of the adhesive to the cavity and UV light to cure the adhesive.

8. The system of claim 6, wherein the carrier is a bottom carrier of a battery pack that includes a top carrier opposite the bottom carrier, with the plurality of battery cells disposed between the top carrier and the bottom carrier.

9. The system of claim 8, wherein the top carrier is planar, the top carrier having a top outer major surface and a top inner major surface opposite the top outer major surface, the top carrier defining a top plurality of battery wells disposed adjacent one another along the top inner major surface,
wherein a top well of the plurality of battery wells defines a top sidewall and a top floor, together defining a top cavity shaped to conform to the cell of the plurality of battery cells and to constrain movement of the cell through the top floor of the carrier and laterally along the top inner major surface of the carrier,
wherein the top floor defines:
a top center aperture; and
a top plurality of apertures organized in at least one top group, the top group spaced apart from the top center aperture,
wherein a portion of the top floor proximal the group is contoured to define a space between the cell when disposed in the top well and fixed in the top well to the top carrier.

10. A method to secure a battery cell to a carrier, the method comprising:
disposing the battery cell in a well of the carrier, the carrier having a planar shape in an X-Y plane, such that the battery cell is aligned to the carrier and constrained from moving along a Z-direction and in the X-Y plane;
disposing a UV-curable-adhesive in the well into contact with the carrier and the battery cell;
broadcasting a UV light through the carrier, through a plurality of apertures disposed in the carrier and in the well, the plurality of apertures being organized in a group that is offset from a center aperture of the well; and
fixing the battery cell in the well of the carrier by curing the UV-curable-adhesive with the UV light.

11. The method of claim 10, wherein the battery cell is one of a plurality of battery cells, and wherein fixing the battery cell in the well occurs simultaneous with other cells of the plurality of battery cells.

12. The method of claim 10, wherein the carrier is a bottom carrier, and further comprising sandwiching the plurality of battery cells between the bottom carrier and a top carrier.

13. The method of claim 12, comprising fixing the battery cell in the bottom carrier and the top carrier simultaneously by curing the UV-curable-adhesive with the UV light.

14. The method of claim 13, wherein broadcasting the UV light comprising broadcasting the UV light through the plurality of apertures disposed in the top carrier.

15. The method of claim 10, wherein fixing the battery cell creates a bond between the plurality of battery cells and the carrier that is equivalent to a bond formed by transmitting UV light through a translucent carrier that does not have the plurality of apertures.

16. A system comprising:
battery cells;
an apparatus comprising:
carriers, formed of an opaque thermoplastic, that fix the battery cells in an array to the apparatus, wherein the carriers are planar and extend in an x-y direction, and include a top carrier and a bottom carrier that are spaced apart from each other in a z-direction, so that the battery cells are sandwiched between the carriers,
wherein at least one of the carriers defines:
an outer major surface and an inner major surface, wherein the outer and inner major surfaces are planar and extend in the x-y direction and are spaced apart from each other in z-direction; and
battery wells, disposed adjacent one another, along the inner major surface,
wherein:
ones of the battery wells define a sidewall and a well floor that conforms with a clearance fit to ones of the battery cells, to thereby define a space around ones of the battery cells within ones of the battery wells;
a cavity is defined in the well floor; and
apertures, each having a smaller diameter than ones of the cells, are defined to extend in the z-direction from the cavity to the outer major surface,
the apertures are UV-curable-adhesive flow-restricting apertures that are configured to commutate, from the outer major surface to the cavity:
a liquid flow of a UV-curable-adhesive, whereby the liquid flow of the UV-curable-adhesive flows to the space around ones of the battery cells within ones of the battery wells; and
UV light, whereby the UV-curable-adhesive is cured within the space around ones of the battery cells within ones of the battery wells, and the battery cells are fixed within the battery wells.

17. The system of claim 16, including the UV-curable-adhesive disposed in the space around ones of the battery cells within ones of the battery wells.

18. The system of claim 16, wherein the battery cells are arranged such that an anode of one or more sets of the battery cells faces the bottom carrier, and a cathode of another one or more sets of the battery cells faces the bottom carrier.

19. The system of claim 16, wherein the carrier is formed of a flame retardant.

20. The system of claim 16, wherein each of the carriers defines:
the outer major surface and the inner major surface; and
the battery wells, disposed adjacent one another, along the inner major surface,
wherein:
ones of the battery wells define the sidewall and the well floor that conforms with the clearance fit to ones of the battery cells, to thereby define the space around ones of the battery cells within ones of the battery wells;
the cavity is defined in the well floor; and
the apertures are defined to extend in the z-direction from the cavity to the outer major surface.
